(19) United States
(12) Patent Application Publication
(10) Pub. No.: US 2020/0044941 A1
(43) Pub. Date: Feb. 6, 2020

(54) MONITORING SYSTEM, IMAGE INFORMATION PROVIDING DEVICE, CLIENT CONTROL DEVICE, IMAGE INFORMATION PROVIDING PROGRAM, AND CLIENT CONTROL PROGRAM

(71) Applicants: Toshiba Energy Systems & Solutions Corporation, Kawasaki-sh (JP); Tokyo Electric Power Company Holdings, Incorporated, Chiyoda-ku (JP)

(72) Inventors: Hiroaki FUJIURA, Yokohama (JP); Masaru KAWAKAMI, Yokohama (JP); Hiroyuki YABE, Kasukabe (JP); Yuji FUJIMOTO, Shiroi (JP); Shinobu KAWASHIMA, Tokorozawa (JP); Koichi TAKEUCHI, Tokyo (JP); Junya YAMAMOTO, Tokyo (JP); Takashi EGUCHI, Tokyo (JP); Tomohiro KUBO, Tokyo (JP); Masanori ENDO, Tokyo (JP); Kenji KITAMI, Tokyo (JP); Takaaki HOSAKA, Tokyo (JP); Jun INOUE, Tokyo (JP)

(73) Assignees: Toshiba Energy Systems & Solutions Corporation, Kawasaki-sh (JP); Tokyo Electric Power Company Holdings, Incorporated, Chiyoda-ku (JP)

(21) Appl. No.: 16/499,082

(22) PCT Filed: Mar. 28, 2018
(86) PCT No.: PCT/JP2018/013012

§ 371 Date: Sep. 27, 2019

(30) Foreign Application Priority Data
Mar. 28, 2017 (JP) 2017-063937

(51) Int. Cl. H04L 12/24; G06F 3/14; G06F 3/0488; G06F 3/0485; G06F 3/0484

(52) U.S. Cl. CPC H04L 41/22; G06F 3/14; H04L 67/42; G06F 3/0485; G06F 3/04842; G06F 3/0488

(57) ABSTRACT

A monitoring system includes a monitoring control device, an image information providing device, and a client control device. The monitoring control device monitors infrastructure facilities and transmits statuses of the infrastructure facilities acquired on the basis of information input from a sensor to the image information providing device. The image information providing device generates original image information on the basis of the infrastructure facility statuses received from the monitoring control device. The client control device is connected to a display device and an operation device, receives information for designating a partial area of an entire image capable of being generated from the original image information from the operation device, transmits the received information to the image information providing device, and displays an image based on information received from the image information providing device on the display device. The monitoring system can cope with change of a monitoring range.

### BACKGROUND OF THE INVENTION

### Field of the Invention

Embodiments of the invention relate to a monitoring system, an image information providing device, a client control device, an image information providing program, and a client control program.

### Description of Related Art

In a monitoring system that monitors infrastructure facilities in the related art, information of infrastructure facilities to be monitored is displayed such that a monitor can easily recognize the information, and the infrastructure facilities to be monitored are managed in an integrated manner. For example, in a load-dispatching office or a substation control center, a mosaic display device, a large projector device, or the like may be installed on a wall surface of a monitoring room and a system diagram of infrastructure facilities in a range under control may be displayed thereon. By displaying the system diagram, it is possible to centrally monitor a system status.

In such a monitoring system, when ranges under control have been removed or consolidated and thus a monitoring range has been changed, a system diagram which has been displayed needs to be changed. When it is intended to change a system diagram, a mosaic display device may have to be prepared again or a projector device that can display a changed monitoring range in a size which can be easily recognized by a monitor or the like may have to be re-installed.

### PATENT DOCUMENTS

[Patent Document 1] Japanese Unexamined Patent Application, First Publication No. 2000-134736

### SUMMARY OF THE INVENTION

An object which needs to be achieved by the invention is to provide a monitoring system, an image information providing device, a client control device, an image information providing program, and a client control program that can easily cope with change of a monitoring range.

A monitoring system according to an embodiment includes a monitoring control device, an image information providing device, and a client control device. The monitoring control device is a monitoring control device that monitors infrastructure facilities and transmits the status of the infrastructure facilities acquired on the basis of information input from a sensor to the image information providing device. The image information providing device generates original image information on the basis of the infrastructure facility statuses received from the monitoring control device. The client control device is connected to a display device and an operation device, receives information for designating a partial area of an entire image capable of being generated from the original image information from the operation device, transmits the received information to the image information providing device, and displays an image based on information received from the image information providing device on the display device. The image information providing device outputs information for displaying a partial area of the entire image, which is determined on the basis of area designation information received from the client control device, to the client control device.

### BRIEF DESCRIPTION OF THE DRAWINGS

FIG. 1 is a system diagram illustrating a configuration of a monitoring system according to an embodiment;

FIG. 2 is a diagram illustrating an example of a current status table 23 which is used in an HMI server according to the embodiment;

FIG. 3 is a diagram illustrating an example in which a monitoring area is displayed in a client control device according to the embodiment;

FIG. 4 is a sequence diagram illustrating an operation of displaying a monitoring area in the monitoring system according to the embodiment;

FIG. 5 is a diagram illustrating an example in which a monitoring area is reduced and displayed in the client control device according to the embodiment;

FIG. 6 is a sequence diagram illustrating an operation of displaying a monitoring area in the monitoring system according to the embodiment;

FIG. 7 is a diagram illustrating an example in which a status change area is displayed in the client control device according to the embodiment;

FIG. 8 is a sequence diagram illustrating an operation of displaying a status change area in the monitoring system according to the embodiment;

FIG. 9 is a diagram illustrating an example in which a plurality of status change areas are displayed in the client control device according to the embodiment;

FIG. 10 is a diagram illustrating an example in which a plurality of status change areas are reduced and displayed in the client control device according to the embodiment;

FIG. 11 is a sequence diagram illustrating an operation of displaying a plurality of status change areas in the monitoring system according to the embodiment;

FIG. 12 is a diagram illustrating an example in which display of a status change is locked in the client control device according to the embodiment;

FIG. 13 is a sequence diagram illustrating an operation of locking display of a status change in the monitoring system according to the embodiment; and

FIG. 14 is a sequence diagram illustrating an operation of displaying a plurality of status change areas after locking display of a status change in the monitoring system according to the embodiment.

### DETAILED DESCRIPTION OF THE INVENTION

Hereinafter, a monitoring system according to an embodiment will be described with reference to the accompanying drawings.

### First Embodiment

First, a first embodiment will be described below.

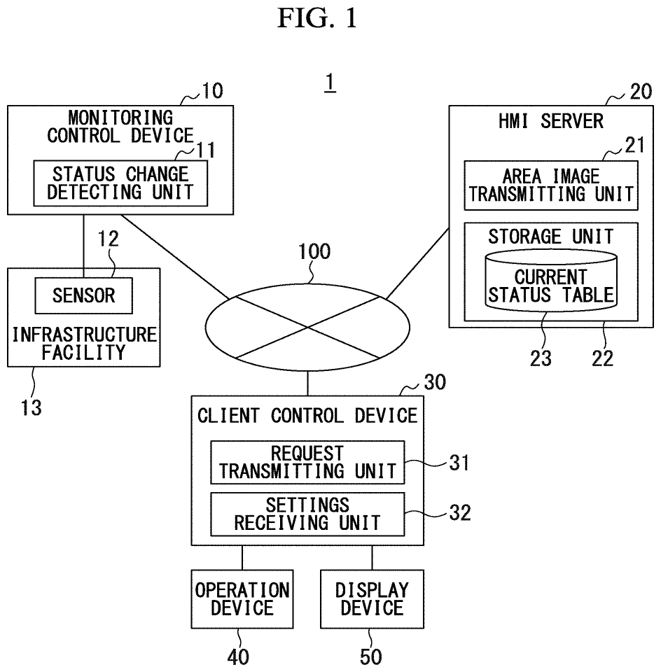

FIG. 1 is a system diagram illustrating a configuration of a monitoring system according to this embodiment. As illustrated in FIG. 1, the monitoring system 1 includes, for example, a monitoring control device 10, a human-machine interface (HMI) server (an image information providing device) 20, and a client control device 30. The monitoring control device 10, the HMI server 20, and the client control device 30 communicate with each other via a network 100. The network 100 may include, for example, some or all of a wide area network (WAN), a local area network (LAN), the Internet, a provider device, a radio base station, and a dedicated line. The client control device 30 and the like connected to the network 100 can serve as access points. In this case, the client control device 30 communicates with an operation device 40 and a display device 50 in a wireless or wired manner and transmits information received from the operation device 40 to the HMI server 20 or transmits image information received from the HMI server 20 to the operation device 40 and the display device 50.

The monitoring control device 10, the HMI server 20, and the client control device 30 are computers including a processor such as a central processing unit (CPU) and a program memory storing a program which is executed by the processor.

A status change detecting unit 11 in the monitoring control device 10, an area image transmitting unit 21 in the HMI server 20, and a request transmitting unit 31 and a settings receiving unit 32 in the client control device 30 are embodied, for example, by causing the processors such as CPUs to execute programs which are stored in the program memories. Some or all of such functional units may be embodied by hardware such as a large scale integration (LSI), an application specific integrated circuit (ASIC), or a field-programmable gate array (FPGA).

A sensor 12 is connected to the monitoring control device 10. The monitoring control device 10 transmits status information indicating the status of infrastructure facilities 13 acquired on the basis of information received from the sensor 12 to the HMI server 20. The infrastructure facilities 13 are facilities which are required for providing civil infrastructure, such as power generation facilities, power distribution and transmission facilities, water treatment facilities, or gas distribution facilities. The infrastructure facilities 13 may be operational infrastructure for the power status of plants or large-scale buildings, distribution facilities in physical distribution centers, or research facilities in schools or research institutes. In this way, the infrastructure facilities 13 include a wide range of facilities which cannot be monitored at a glance and thus are facilities that are preferably centrally monitored in one place.

The monitoring control device 10 includes, for example, a status change detecting unit 11. The status change detecting unit 11 detects change of status of the infrastructure facilities 13 on the basis of information from the sensor 12. An example of the changes of status of the infrastructure facilities 13 is that power failure has occurred in a normal state in a case in which a load-dispatching office is monitored. The status change detecting unit 11 stores, for example, information received from the sensor 12 in a storage area which is not illustrated to detect changes of status. The status change detecting unit 11 compares newly received information with the information stored in the storage area when information has been newly received from the sensor 12, and determines that change of status has been detected when the two pieces of information are different from each other. The status change detecting unit 11 may compare information from the sensor 12 with a predetermined threshold value and determine that change of status has been detected when the information from the sensor 12 is equal to or less than the threshold value. The status change detecting unit 11 transmits the detected changes of status as status change information to the HMI server 20.

In FIG. 1, the sensor 12 is illustrated as outputting information to the monitoring control device 10 without it passing through the network 100, but the sensor 12 may transmit information to the monitoring control device 10 via the network 100.

The HMI server 20 generates original image information on the basis of status information received from the monitoring control device 10. Here, original image information is, for example, information which can be used to generate an image of a system diagram (hereinafter referred to as an entire image) in which statuses of monitoring points in the whole area under control appear.

Examples of information which can be used to generate an image include a reference such as a uniform resource locator (URL) for specifying a location of an image in a web server which is not illustrated on the network 100 or compressed image data, bit map data, vector data, and the like constituting an image. Another example of information which can be used to generate an image may be element data indicating numerical values, colors, and the like of elements (monitoring points or the like) in an outline of an image in a case in which the client control device 30 stores the outline of an image such as a system diagram.

The HMI server 20 includes, for example, an area image transmitting unit 21 and a storage unit 22. The area image transmitting unit 21 determines image information (hereinafter referred to as area image information) for displaying a partial area of the entire image capable of being generated from the original image information on the basis of area designation information received from the client control device 30. The area image transmitting unit 21 transmits the determined area image information to the client control device 30.

When information (hereinafter referred to as status change information) indicating changes of status is included in status information received from the monitoring control device 10, the area image transmitting unit 21 updates a current status table 23 in which changes of status are stored.

The storage unit 22 is realized, for example, by a hard disc drive (HDD), a flash memory, an electrically erasable programmable read only memory (EEPROM), or a random access memory (RAM). The storage unit 22 stores the current status table 23.

The current status table 23 is a data table that is used to manage a current monitoring state and a display state on the client control device on the basis of the status information received from the monitoring control device 10 and the information received from the client control device 30.

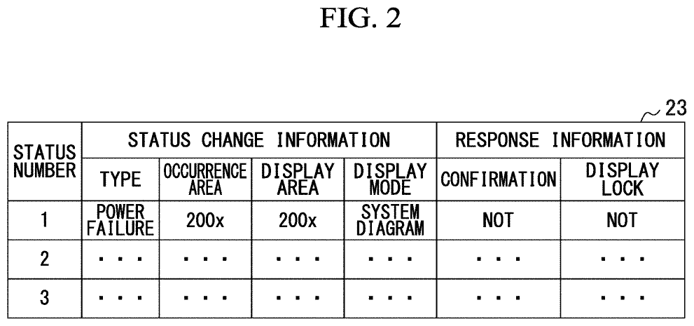

FIG. 2 illustrates an example of details of the current status table 23. As illustrated in FIG. 2, the current status table 23 includes fields of status number, status change information, and confirmation information. In the field of status number, a number indicating the order in which changes of status have been received is stored. In the field of status change information, details of status change information received from the monitoring control device 10 are stored. In the field of confirmation information, details of information (hereinafter referred to as response information) indicating a response from the client control device 30 to image information transmitted from the HMI server 20 when changes of status occurs are stored.

The status change information additionally includes fields of type, occurrence area, display area, and display mode. In the field of type, a type of the status change such as power failure or power failure recovery is stored. In the field of occurrence area, information on an area in which a status change has occurred is stored. In the field of display area, an area which is displayed on the basis of image information transmitted from the area image transmitting unit 21 to the client control device 30 is stored. In the field of display mode, a type of image displayed such as whether an image which is displayed using image information transmitted from the area image transmitting unit 21 to the client control device 30 is a system diagram is stored.

The field of response information additionally includes fields of confirmation and display lock. In the field of confirmation, information indicating whether a response indicating confirmation (hereinafter referred to as confirmation response information) has been received from the client control device 30 in response to display of an area in which a status change has occurred is stored. In the field of display lock, information indicating whether a response indicating a display fixing (locking) request (hereinafter referred to as lock response information) has been received from the client control device 30 in response to display of an area in which a status change has occurred is stored.

The area image transmitting unit 21 determines area image information for displaying an area in which a status change has occurred on the basis of the status change information received from the monitoring control device 10. The area image transmitting unit 21 transmits the determined area image information to the client control device 30.

The area image transmitting unit 21 updates the current status table 23 when information (hereinafter referred to as lock designation information) indicating that fixed display (locking) of display of an area in which a status change has occurred is designated is received from the client control device 30.

The client control device 30 will be described below with reference back to FIG. 1. The client control device 30 is connected to an operation device 40 and a display device 50. The client control device 30 receives area designation information for designating a partial area of an entire image capable of being generated from original image information from the operation device 40. The client control device 30 transmits the area designation information received from the operation device 40 to the HMI server 20. The client control device 30 includes a request transmitting unit 31 and a settings receiving unit 32. The request transmitting unit 31 transmits the area designation information to the HMI server 20. The settings receiving unit 32 receives operation information such as the area designation information from the operation device 40.

The operation device 40 allows operations on an image which is displayed on the display device 50. The operation device 40 includes an operation input unit that allows operations on an image which is displayed on the display device 50 and a communication unit that transmits and receives area designation information based on the operation information input by the operation input unit to and from the client control device 30. The operation device 40 is, for example, a tablet terminal including a touch panel as the operation input unit. In this case, the operation device 40 enables an operation of changing, enlarging, or reducing a picture which is displayed on the display device 50 by the touch panel on which the same image as the picture which is displayed on the display device 50 being operated is displayed. The operation device 40 may be a smartphone, a notebook computer or desktop personal computer, or the like.

The display device 50 receives image information from the client control device 30 and displays an image corresponding to the received image information. The display device 50 includes a display unit that displays an image and a communication unit that communicates with the client control device 30. The display device 50 is, for example, a large-size monitor (for example, of about 70 inches).

Communication between the client control device 30 and the operation device 40 may be carried out, for example, in a wireless communication manner via a Wi-Fi network. Communication between the client control device 30 and the operation device 40 may be carried out via a radio communication network such as a cellular network, a short-range radio communication network such as an infrared communication network or Bluetooth (registered trademark), or a wired communication network via a local area network (LAN) or the like.

Communication between the client control device 30 and the display device 50 may be carried out, for example, via a high-definition multimedia interface (HDMI: registered trademark) cable or a universal serial bus (USB) cable. When the client control device 30 and the display device 50 are connected to each other via an HDMI cable, the display device 50 displays an image on the basis of pixel information received from the HDMI cable. That is, when the client control device 30 and the display device 50 are connected to each other via an HDMI cable, the display device 50 does not have an image generating function, and an image is generated by the client control device 30 or image information received by the client control device 30 is image information which is expressed in bit map data or the like. Communication between the client control device 30 and the display device 50 may be carried out in the same communication manner as the communication between the client control device 30 and the operation device 40 such as via a Wi-Fi network.

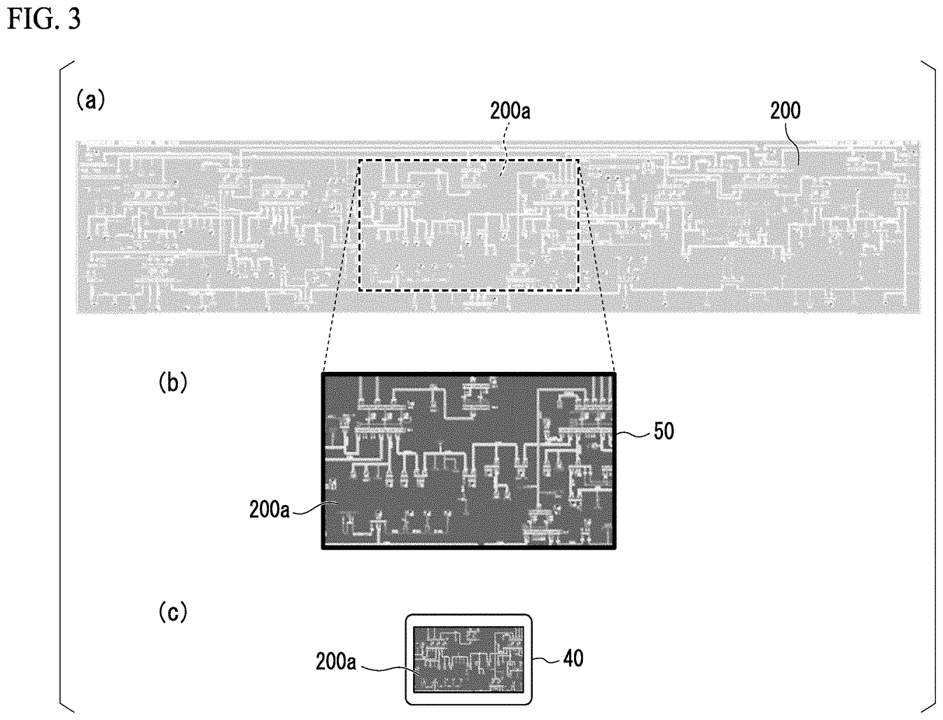

An example in which a monitoring area is displayed by the display device 50 will be described below with reference to FIG. 3. FIG. 3 is a diagram illustrating a state in which a monitoring area is displayed by the display device 50 according to the embodiment. FIG. 3(a) is a diagram illustrating an entire image capable of being generated from original image information which is generated by the HMI server 20. FIG. 3(b) illustrates an example of an area image which is displayed by the display device 50. FIG. 3(c) illustrates an example of an area image which is displayed by the operation device 40.

An entire image 200 illustrated in FIG. 3(a) is, for example, a system diagram which is displayed on one wall surface of a monitoring room in the related art. An area image 200a illustrated in FIG. 3(a) is a partial area of the entire image 200 which is determined on the basis of area designation information received from the client control device 30.

As illustrated in FIG. 3(b), the display device 50 displays the area image 200a corresponding to image information received from the HMI server 20 on the basis of the area designation information. In this way, by displaying a monitoring area represented by the area image 200a on the display device 50, a monitor can monitor an area represented by the area image 200a.

As illustrated in FIG. 3(c), the operation device 40 displays the same image as the image which is displayed by the display device 50. By displaying the same image as the image which is displayed by the display device 50 on the operation device 40, a monitor or the like can touch the image displayed on the operation device 40 while watching the image and perform operations on the image which is displayed on the display device 50. For example, a monitor or the like can move (scroll) a position of the area image 200a in the entire image 200 by touching a display screen of the operation device 40 and performing a sliding operation to the right or left. When a monitor or the like operates the operation device 40, operation information is transmitted to the HMI server 20 via the client control device 30, and image information based on the operation information is transmitted from the HMI server 20 to the client control device 30. The operation is reflected in the image of the display device 50 displayed by the client control device 30. With this structure, operations can be performed on an image which is displayed on the display device 50.

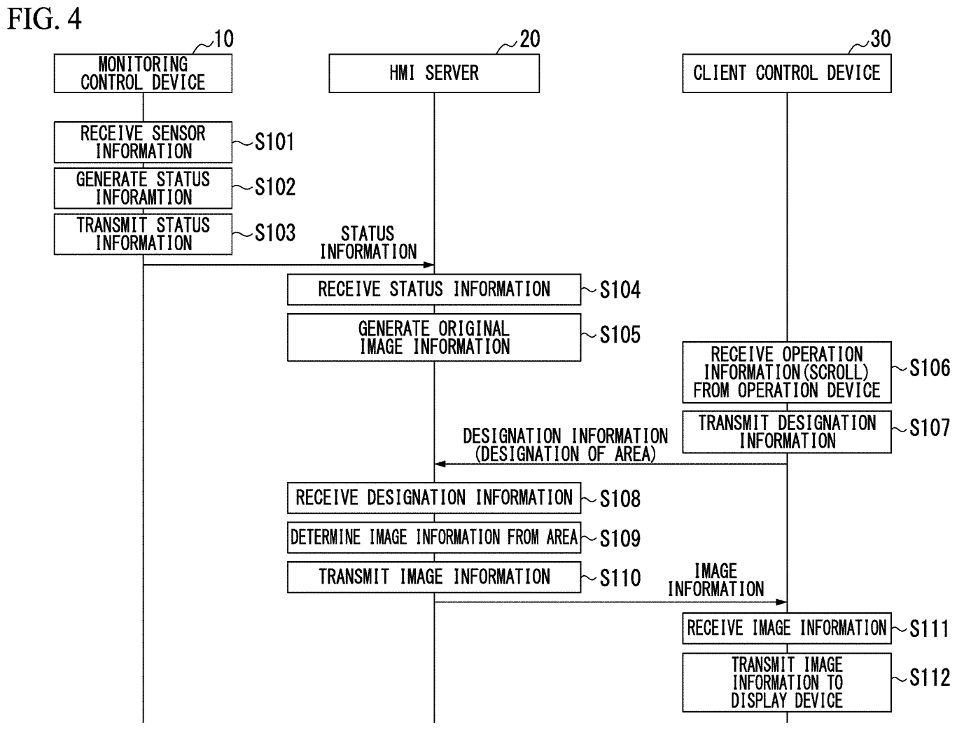

The operation illustrated in FIG. 3 will be described below with reference to FIG. 4. FIG. 4 is a sequence diagram illustrating an operation of displaying a monitoring area in the monitoring system 1 according to the embodiment.

The monitoring control device 10 receives sensor information from the sensor 12 (Step S101) The monitoring control device 10 generates status information on the basis of the received sensor information (Step S102). The monitoring control device 10 transmits the status information to the HMI server 20 (Step S103).

The HMI server 20 receives the status information from the monitoring control device 10 (Step S104). The HMI server 20 generates original image information from the received status information (Step S105).

On the other hand, the client control device 30 receives operation information of a scroll operation or the like from the operation device 40 (Step S106). The client control device 30 generates area designation information based on the received operation information and transmits the area designation information to the HMI server 20 (Step S107).

The HMI server 20 receives the area designation information from the client control device 30 (Step S108). The HMI server 20 determines image information on the basis of the received area designation information (Step S109). Here, the image information which is determined by the HMI server 20 is image information corresponding to the whole or a partial area of the original image information. The HMI server 20 transmits the determined image information to the client control device 30 (Step S110).

The client control device 30 receives the image information from the HMI server 20 (Step S111). The client control device 30 transmits the received image information to the operation device 40 and the display device 50 (Step S112).

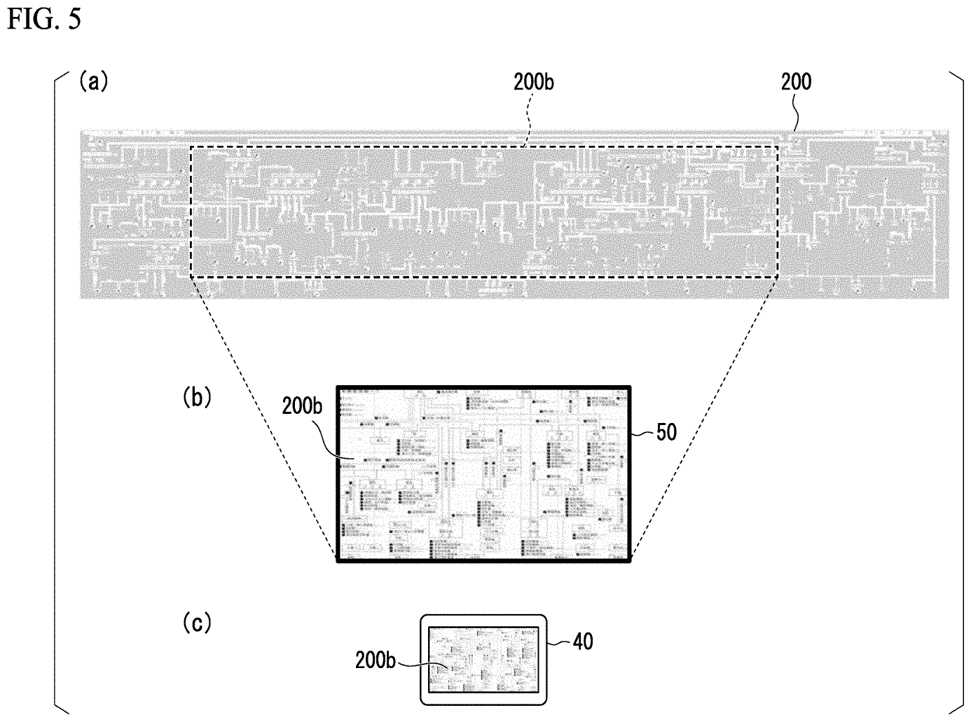

An example in which an image indicating a monitoring area which is displayed by the display device 50 is displayed as an image which is different from the image illustrated in FIG. 3 will be described below with reference to FIG. 5. FIG. 5 is a diagram illustrating an example in which a monitoring area is reduced and displayed by the display device 50 according to the embodiment. FIG. 5(a) is the same diagram as FIG. 3(a), except that an area image 200b in FIG. 5(a) represents a wider area than the area image 200a in FIG. 3(a). FIG. 5(b) is the same diagram as FIG. 3(b), except that an overall system diagram is displayed instead of the system diagram. Here, an overall system diagram refers to a diagram which expresses a system diagram in a macro manner. FIG. 5(c) is the same diagram as FIG. 3(c). The overall system diagram is an example of an “overall image.”

The diagram which is displayed in a macro manner is, for example, a diagram in which smaller elements are displayed more in the same area. Here, the diagram which is displayed in a macro manner is an example of an “image which is generated from a macro-perspective.” When all of a large number of elements are displayed in an area and thus become too small for the status thereof to be understood, or the like, the overall status can be easily understood by displaying a diagram in a macro manner.

As described above with reference to FIG. 3(c), the operation device 40 allows operations on an area which is displayed on the display device 50 by scrolling the same image as the image which is displayed by the display device 50. In this case, a monitor or the like can reduce the size of a place on the area image 200a by touching the display screen of the operation device 40 with two fingers and performing an operation of bringing the two fingers touching the screen closer to each other (pinching in). A monitor or the like can enlarge the position of the area image 200a by performing an operation of separating two fingers touching the screen (pinching out).

As illustrated in FIG. 5(a), when a display area which is displayed in the area image 200b determined on the basis of the area designation information received from the client control device 30 is relatively wide, that is, when a display magnification at which the area image is displayed on the display device 50 is relatively small, the HMI server 20 transmits image information of an overall system diagram of the area image 200b to the client control device 30. When the image information of the overall system diagram is transmitted from the HMI server 20, the display device 50 displays the overall system diagram of the area image 200b as illustrated in FIG. 5(b). As illustrated in FIG. 5(c), the operation device 40 displays the same image as the image displayed on the display device 50 similarly to FIG. 3(c).

When a display range in a system diagram corresponding to the area image 200b is excessively wide, the system diagram is displayed excessively small and a monitor or the like cannot understand a system status included in the system diagram even if the system diagram of the corresponding area is displayed on the display device 50 similarly to FIG. 3(b). In this case, by causing the HMI server 20 to display the overall system diagram illustrated in FIG. 5(b) on the client control device 30, a monitor or the like can understand the system status.

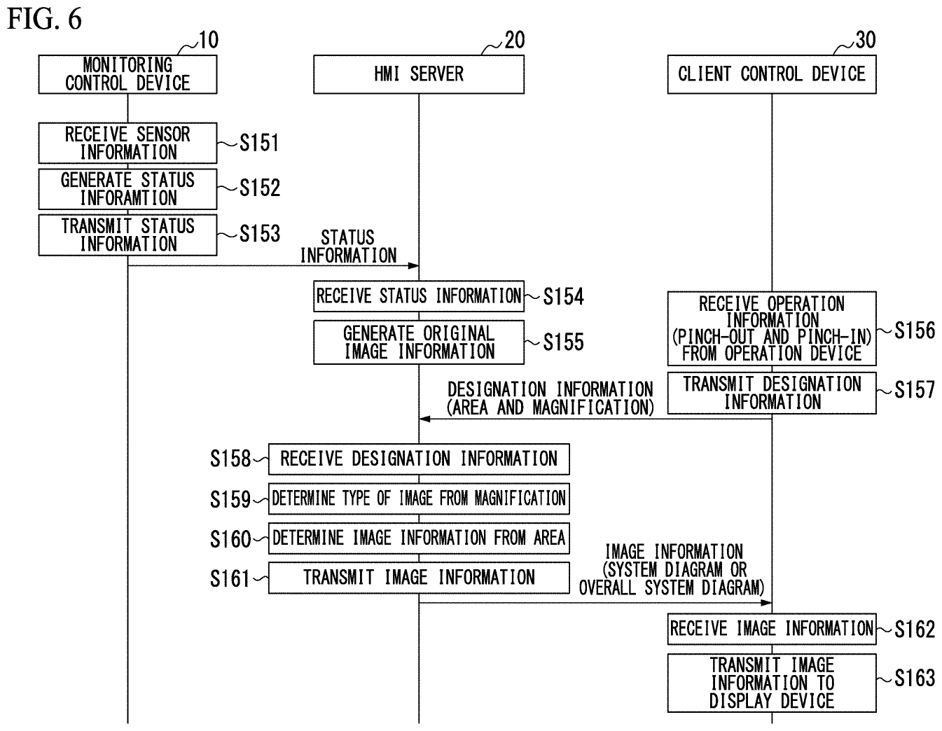

The operation illustrated in FIG. 5 will be described below with reference to FIG. 6. FIG. 6 is a sequence diagram illustrating an operation of displaying a monitoring area in the monitoring system 1 according to the embodiment.

The processes of Steps S151 to S155 in the sequence chart illustrated in FIG. 6 are the same as the processes of Steps S101 to S105 in the sequence chart illustrated in FIG. 4 and thus description thereof will not be repeated.

The client control device 30 receives operation information based on a pinch-out or pinch-in operation from the operation device 40 (Step S156). The client control device 30 generates designation information including area designation information and display magnification designation information on the basis of the received operation information and transmits the designation information to the HMI server 20 (Step S157).

The HMI server 20 receives the designation information from the client control device 30 (Step S158). The HMI server 20 determines a type of an image (a system diagram or an overall system diagram) which is transmitted to the client control device 30 on the basis of the display magnification designation information included in the received designation information (Step S159). The HMI server 20 determines image information on the basis of the area designation information included in the received designation information (Step S160). The HMI server 20 transmits the determined image information to the client control device 30 (Step S161).

The client control device 30 receives the image information from the HMI server 20 (Step S162). The client control device 30 transmits the received image information to the operation device 40 and the display device 50 (Step S163).

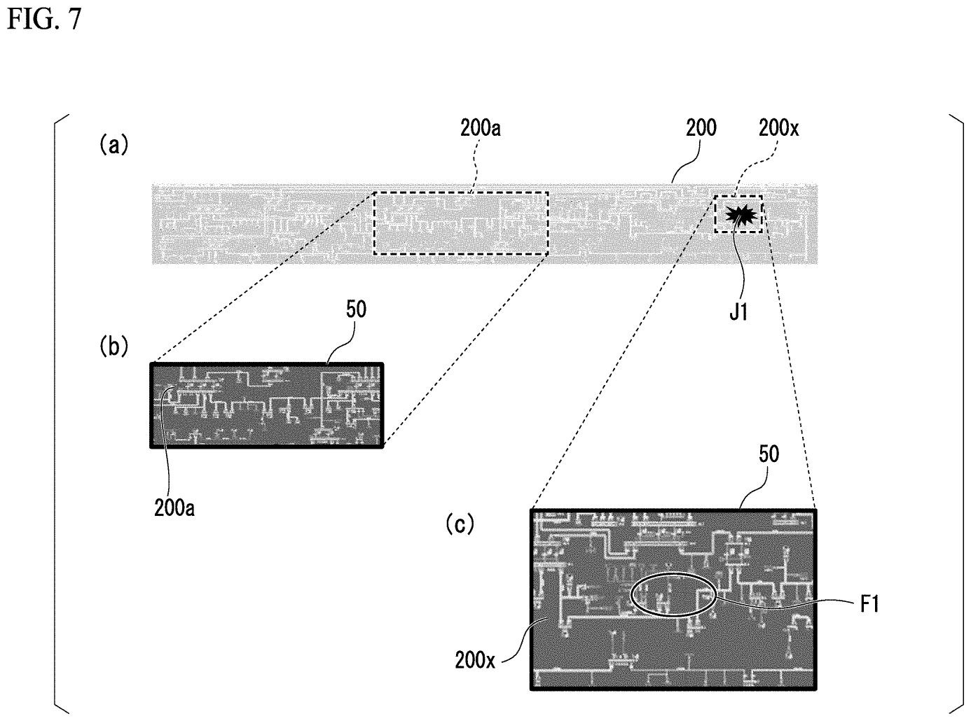

An example in which an area in which a status change has occurred is displayed on the display device 50 will be described below with reference to FIG. 7. FIG. 7 is a diagram illustrating an example in which a monitoring area is displayed on the display device 50 according to the embodiment. FIG. 7(a) is the same diagram as FIG. 3(a), except that a status change mark J1 indicating that a status change has occurred appear in an area image 200x which is different from the area image 200a in the entire image 200. FIG. 7(b) is the same as FIG. 3(b). FIG. 7(c) illustrates a display example in which the image illustrated in FIG. 7(b) is switched to a system diagram of an area in which a status change has occurred due to occurrence of the status change.

As illustrated in FIG. 7(a), when a status change has occurred in a place in the area image 200x, the HMI server 20 transmits image information of a system diagram of the area image 200x to the client control device 30 regardless of the image which is displayed on the display device 50. Accordingly, when a status change occurs in the area image 200x, for example, when the display device 50 is displaying the area image 200a as illustrated in FIG. 7(b), the display of the display device 50 is automatically switched from the area image 200a to the area image 200x as illustrated in FIG. 7(c).

For example, when a status change occurs in a place of the area image 200x, the monitoring system 1 according to the embodiment can notify a monitor or the like that the status change has occurred in a monitoring area by switching display of the display device 50 to the area image 200x in which the status change has occurred. The monitoring system 1 according to the embodiment highlights the place in which the status change has occurred by flickering an area image F1 indicating the place in which the status change has occurred in the area image 200x. At this time, the monitoring system 1 may further highlight the area image F1 by changing a background color of the area image F1 to a color which is different from the background color of the other area in which a status change has not occurred. The monitoring system 1 may notify a monitor or the like that the status change has occurred using a speech output device or the like which is not illustrated in the client control device 30 by siren sound, announced speech, or the like.

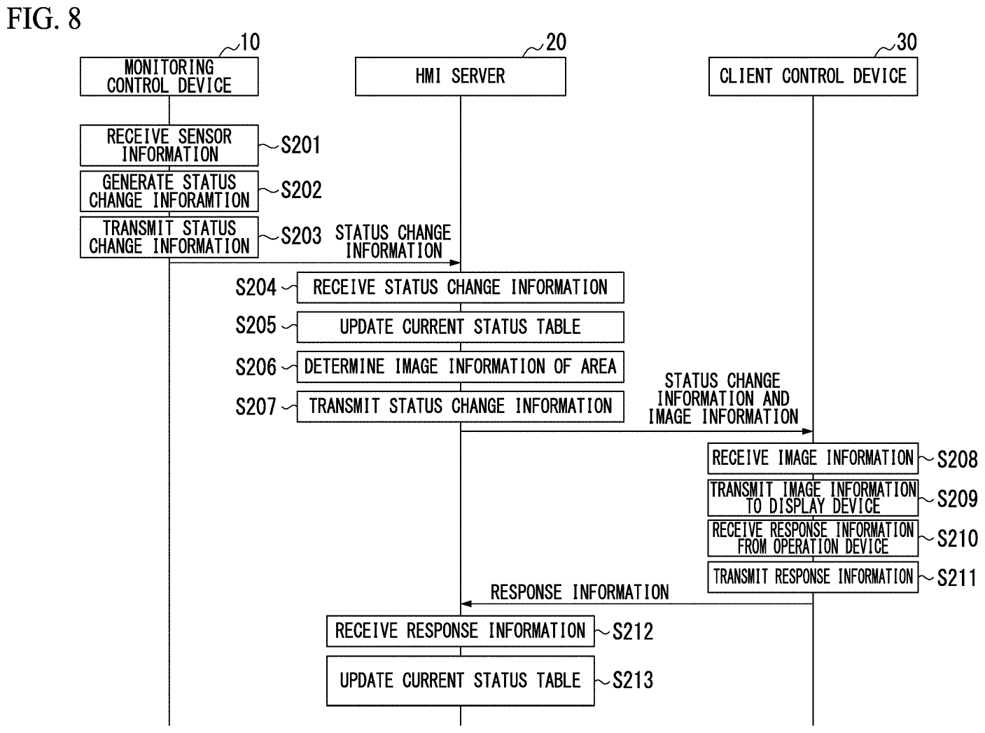

The operation illustrated in FIG. 7 will be described below with reference to FIG. 8. FIG. 8 is a sequence diagram illustrating an operation of displaying an area in which a status change has occurred in the monitoring system 1 according to the embodiment.

The monitoring control device 10 receives sensor information from the sensor 12 (Step S201). The monitoring control device 10 generates status change information when it is determined that a status change has occurred on the basis of the received sensor information (Step S202). The monitoring control device 10 transmits the status change information to the HMI server 20 (Step S203).

An example of actual statuses of the infrastructure facilities 13 when a status change has occurred will be described below. The sensor 12 includes, for example, a circuit breaker that is installed in a power supply line which is monitored, an electromagnetic relay corresponding to the circuit breaker, and a relay control unit that controls an operation of the electromagnetic relay, and the electromagnetic relay which is controlled by the relay control unit switches the circuit breaker to a disconnected state or a connected state. When a short circuit or the like occurs in the power supply line, the circuit breaker installed in the power supply line in which the short circuit has occurred is switched to the disconnected state. By changing the circuit breaker to the disconnected state, the status of the electromagnetic relay changes. In general, when a short circuit or the like occurs in a power supply line, the status change of the electromagnetic relay occurs slightly later than the time at which the status change in the circuit breaker has occurred.

When a short circuit or the like occurs in a power supply line, the sensor 12 transmits the status change in the circuit breaker to the monitoring control device 10. The monitoring control device 10 transmits the received status change to the status change detecting unit 11.

When a short circuit or the like occurs in a power supply line, the status change detecting unit 11 receives the status change of the electromagnetic relay slightly later than the status change of the circuit breaker. In this case, the status change detecting unit 11 needs to handle the status change of the circuit breaker and the status change of the electromagnetic relay as status changes due to occurrence of a single short circuit or the like. Accordingly, when the status change detecting unit 11 receives a status change, the status change detecting unit 11 handles status changes received until a predetermined time (for example, three seconds) elapses after the time at which the status change has received as a single status change. In this way, by receiving status changes until a predetermined time elapses, the status change detecting unit 11 can prevent the relevant status changes from being erroneously recognized as being due to other events or prevent the relevant status changes from being missed.

The HMI server 20 receives status change information from the monitoring control device 10 (Step S204). The HMI server 20 stores the type of the status change, the area in which the status change has occurred, and the like in the current status table 23 on the basis of the received status change information and updates the current status table 23 (Step S205). The HMI server 20 determines image information on the basis of the received status change information (Step S206). Here, the image information which is determined by the HMI server 20 is image information for displaying an area in which the status change indicated by the status change information has occurred.

The HMI server 20 transmits the determined image information to the client control device 30 (Step S207). The client control device 30 receives the image information from the HMI server 20 (Step S208). The client control device 30 transmits the received image information to the operation device 40 and the display device 50 (Step S209). Accordingly, a system diagram of an area in which the status change has occurred is displayed on the display device 50 and a monitor or the like visually recognizes the image.

When a monitor or the like recognizes the area in which the status change has occurred which is displayed on the display device 50, the monitor or the like operates an operation device (hereinafter referred to as an operation console) different from the operation device 40 or the operation device 40 and transmits response information indicating that display of the area in which the status change has occurred as been confirmed. The client control device 30 receives the response information from the operation console or the operation device 40 (Step S210). The client control device 30 transmits the received response information to the HMI server 20 (Step S211).

The HMI server 20 receives the response information from the client control device 30 (Step S212). The HMI server 20 updates the current status table 23 on the basis of the received response information (Step S213).

When a response indicating that the area in which the status change has occurred has been confirmed is included in the received response information, the HMI server 20 transmits information for displaying an area which is determined on the basis of the area designation information from the client control device 30 to the client control device 30.

In this case, the HMI server 20 may stop flickering of the area image F1 and transmit an image for returning the display to the same display as the other area in which the status change does not occur to the client control device 30 instead of transmitting the information for displaying the area which is determined on the basis of the area designation information from the client control device 30. When the background color of the area image F1 is different from the background color of the other area in which the status change does not occur, the HMI server 20 may transmit information for displaying back the background color of the area image F1 to the same color as the background color of the other area in which the status change does not occur to the client control device 30.

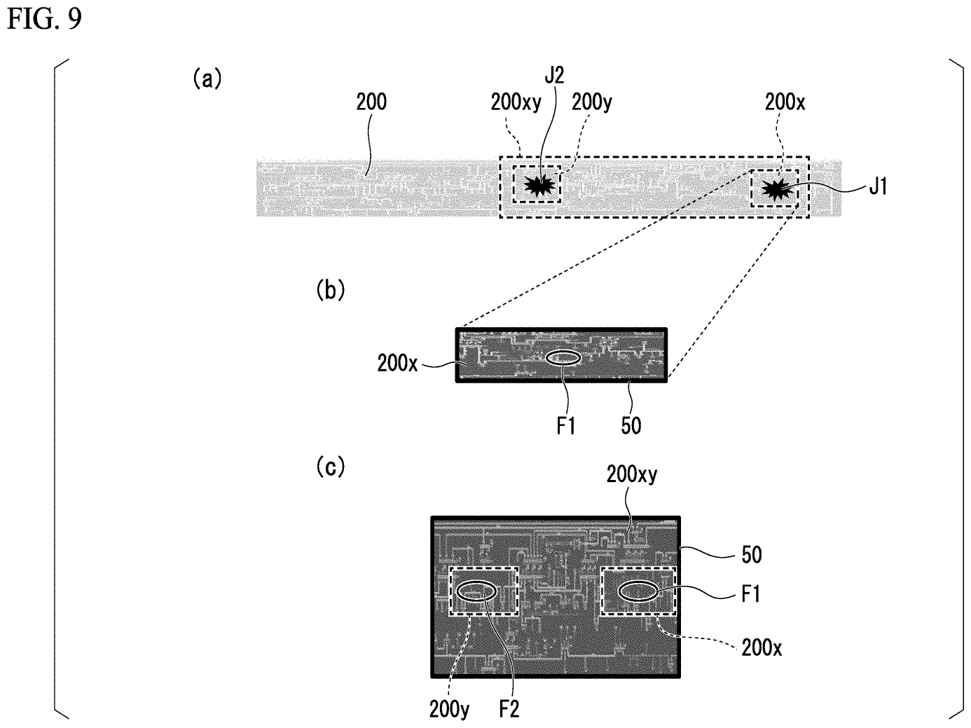

A display example in which a plurality of areas in which a status change has occurred are displayed on the display device 50 will be described below with reference to FIG. 9. FIG. 9 is a diagram illustrating an example in which a monitoring area is displayed on the display device 50 according to the embodiment. FIG. 9(a) is the same diagram as FIG. 7(a), except that a status change mark J2 indicating that a status change has occurred in places in an area image 200y other than the area image 200x is illustrated. FIG. 9(b) is the same diagram as FIG. 7(c). FIG. 9(c) illustrates a display example in which the image illustrated in FIG. 9(b) is switched to a system diagram of an area including all the areas in which a status change has occurred due to occurrence of a status change in a plurality of places. Here, the area including all the areas in which the status change has occurred is an example of a “plurality of areas.”

When a status change occurs in a place included in the area image 200x and a status change occurs in a place included in the area image 200y as illustrated in FIG. 9(a), the HMI server 20 transmits image information of a system diagram of an area image 200xy including the area image 200x and the area image 200y to the client control device 30. Accordingly, when a status change occurs in the area image 200y while the display device 50 is displaying the area image 200x and the area image F1 is being flickered as illustrated in FIG. 9(b), display of the display device 50 is automatically switched from the area image 200x to the area image 200xy as illustrated in FIG. 9(c).

When a status change has occurred in a place included in the area image 200x in addition to the place included in the area image 200x, the monitoring system 1 according to the embodiment can notify a monitor or the like of all the places in which a status change has occurred in the monitoring area by switching display of the display device 50 to the area image 200xy including the area image 200x and the area image 200y.

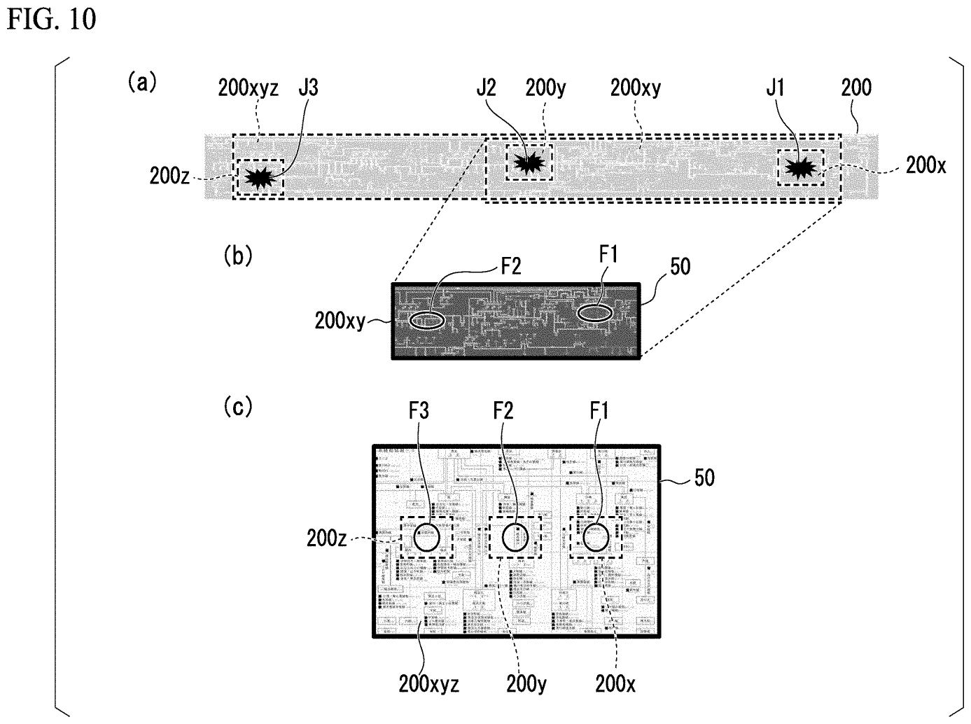

A display example in which an area in which a status change has occurred and which is displayed on the display device 50 is wider than the display area illustrated in FIG. 9(c) will be described below with reference to FIG. 10. FIG. 10 is a diagram illustrating an example in which a monitoring area is displayed on the display device 50 according to the embodiment. FIG. 10(a) is the same diagram as FIG. 9(a), except that a status change mark J3 indicating that a status change has occurred in a place included in an area image 200z other than the area images 200x and 200y is illustrated. FIG. 10(b) is the same diagram as FIG. 9(c). FIG. 10(c) illustrates a display example in which the image illustrated in FIG. 10(b) is switched to an overall system diagram of an area including all the areas in which a status change has occurred due to occurrence of a status change in more places.

When a status change occurs additionally in a place included in the area image 200x, a status change occurs in a place included in the area image 200y, and a status change occurs additionally in a place included in the area image 200z as illustrated in FIG. 10(a), the HMI server 20 performs a process of transmitting image information of an area image 200xyz including the area image 200x, the area image 200y, and the area image 200z. However, in this case, since the area including the places illustrated in the area image 200xyz is wide, the HMI server 20 transmits the overall system diagram of the area image 200xyz to the client control device 30 instead of the system diagram of the area image 200xyz. Accordingly, when a status change has occurred in the area image 200z while the display device 50 is displaying the system diagram of the area image 200xy and area images F1 and F2 are being flickered as illustrated in FIG. 10(b), display of the display device 50 is automatically switched from the system diagram of the area image 200xy to the overall system diagram of the area image 200xyz as illustrated in FIG. 10(c).

In this way, the HMI server 20 displays an overall system diagram when it is intended to switch the display from the area image 200xy to the area image 200xyz but the display of the system diagram is excessively small and a monitor has difficulty in understanding system statuses included in the system diagram if the system diagram of the area indicated by the area image 200xyz is displayed on the display device 50. By displaying the overall system diagram, the monitor can easily understand the system statuses.

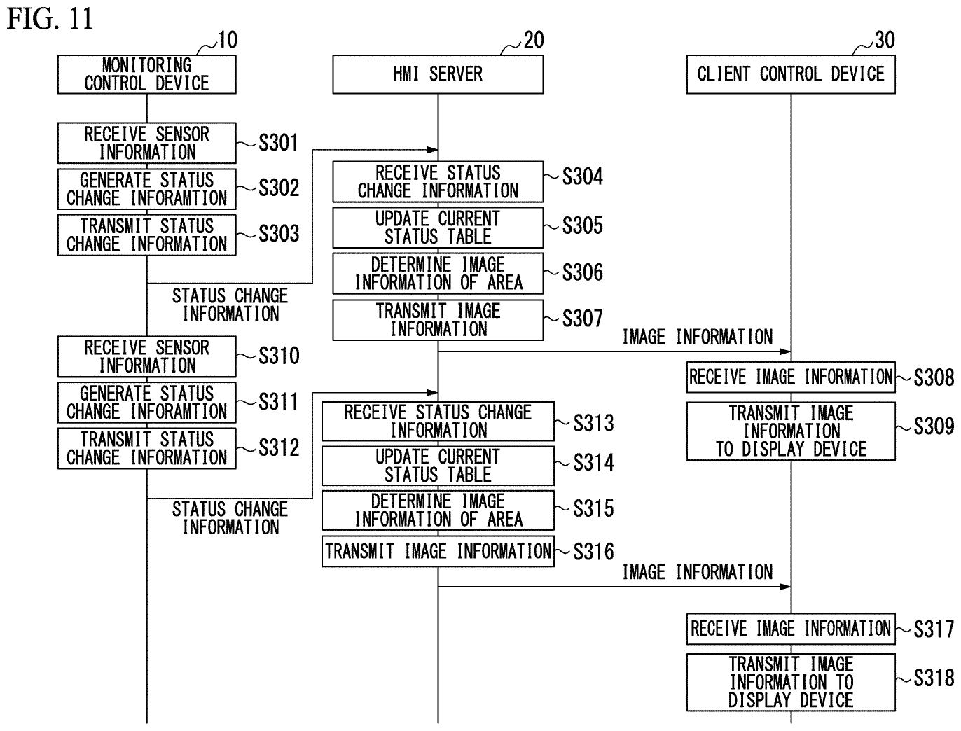

The operations illustrated in FIGS. 9 and 10 will be described below with reference to FIG. 11. FIG. 11 is a sequence diagram illustrating an operation of displaying an area in which a status change has occurred in the monitoring system 1 according to the embodiment.

The processes of Steps S301 to S309 in the sequence chart illustrated in FIG. 11 are the same as the processes of Steps S201 to S209 in the sequence chart illustrated in FIG. 8 and thus description thereof will not be repeated.

The processes of Steps S310 to S312 in the sequence chart illustrated in FIG. 11 are the same as the processes of Steps S201 to S203 in the sequence chart illustrated in FIG. 8 and thus description thereof will not be repeated.

The HMI server 20 receives status change information from the monitoring control device 10 (Step S313). The HMI server 20 stores the type of the status change, the area in which the status change has occurred, and the like in the current status table 23 on the basis of the received status change information and updates the current status table 23 (Step S314). The HMI server 20 determines image information on the basis of the received status change information (Step S315). Here, the image information which is determined by the HMI server 20 is image information for displaying an area in which the status change indicated by the status change information has occurred.

The HMI server 20 refers to the updated current status table 23 in order to determine image information. When a plurality of pieces of status change information are stored in the current status table 23, the HMI server 20 refers to response information for each of the plurality of pieces of status change information stored in the current status table. The HMI server 20 determines an area including all areas in which a status change has occurred which is included in the status change information for which the response information has not been received among the plurality of pieces of status change information. The HMI server 20 determines the image information of the system diagram corresponding to the determined area when the determined area is within a predetermined range, and determines the image information of the overall system diagram corresponding to the determined area when the determined area departs from the predetermined range.

The HMI server 20 transmits the determined image information to the client control device 30 (Step S316). The client control device 30 receives the image information from the HMI server 20 (Step S317) The client control device 30 transmits the received image information to the operation device 40 and the display device 50 (Step S318).

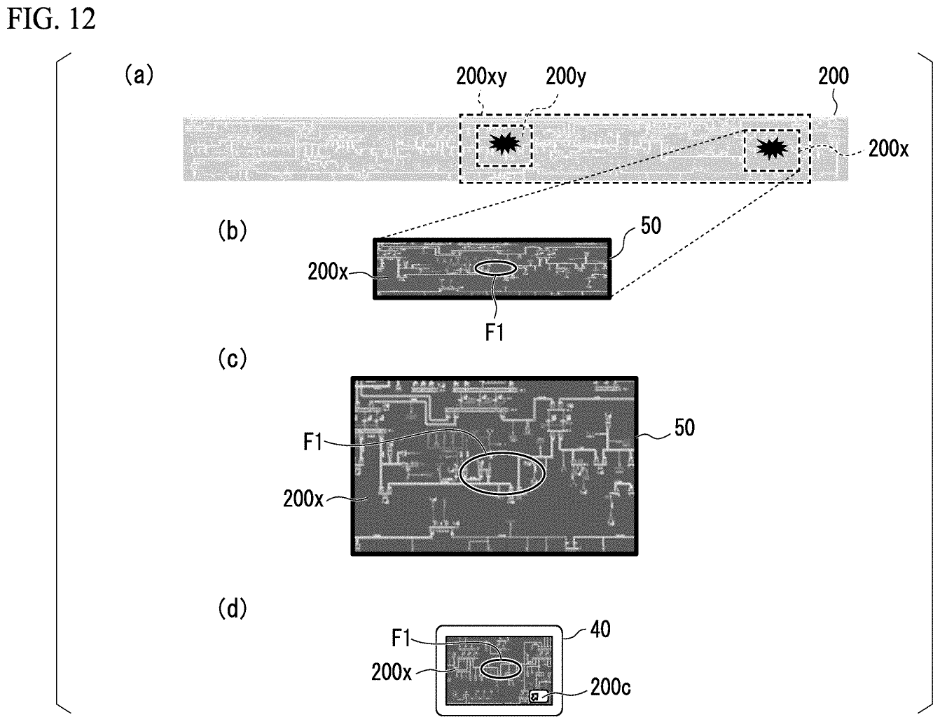

A display example in which there are a plurality of areas in which a status change has occurred and which is displayed on the display device 50 and which is different from that in FIG. 9 will be described below with reference to FIG. 12. FIG. 12 is a diagram illustrating an example in which a monitoring area is displayed on the display device 50 according to the embodiment. FIG. 12(a) is the same diagram as FIG. 9(a). FIG. 12(b) is the same diagram as FIG. 9(b). FIG. 12(c) is the same diagram as FIG. 9(b). FIG. 12(d) is a diagram in which the same image as the image displayed on the display device 50 in FIG. 12(c) is displayed on the operation device 40 and an icon image 200c of an arrow is illustrated in a lower-right part of the screen. Here, the icon image 200c is an example of a “shortcut icon.”

When a status change occurs in a place included in the area image 200x and a status change occurs in a place included in the area image 200y as illustrated in FIG. 12(a), the HMI server 20 performs a process of transmitting image information of a system diagram of an area image 200xy including the area image 200x and the area image 200y. However, when a lock request is received from the client control device 30, the HMI server 20 does not transmit image information of the system diagram of the area image 200xy. Instead, the HMI server 20 transmits image information of the system diagram of the area image 200x and image information of the icon image 200c (for example, an icon image indicating a shortcut) to the client control device 30. Accordingly, when a status change occurs in the area image 200y while the display device 50 is displaying the area image 200x and flickering the area image F1 as illustrated in FIG. 12(b), the display device 50 displays an image indicating the same area as illustrated in FIG. 12(b) as illustrated in FIG. 12(c). That is, display of the display device 50 is fixed (locked) to the area image 200x. Then, as illustrated in FIG. 12(d), the icon image 200c indicating that a status change has occurred in an area other than the locked image (the area image 200x herein) is displayed in the lower-right part of the display screen of the operation device 40.

In the monitoring system 1 according to the embodiment, when information indicating whether display is locked or not is stored in the field of display lock in the response display of the current status table 23, only the place in which the status change has occurred at the first time is continuously displayed on the display device 50 even if a status change has occurred in a plurality of places. An image indicating that the status change has occurred in a plurality of places is displayed on the operation device 40.

The information indicating whether display is locked or not is written to and stored in the current status table 23 in advance. The HMI server 20 may not change the information indicating whether display is locked or not from the information stored in advance. Alternatively, the HMI server 20 may update the current status table 23 and change the information indicating whether display is locked or not when a request signal for requesting locking of display has been received from the client control device 30, or the like.

By displaying the area image 200x without switching the display image of the display device 50 to the area image 200xy, it is possible to prevent the display image from being unintentionally switched before a monitor understand the status change.

In this case, the monitoring system 1 according to the embodiment displays the icon image 200c indicating a shortcut for switching to the area image 200xy, for example, in the lower-right part of the screen of the operation device 40 instead of displaying the area image 200x without switching to the area image 200xy.

By displaying the icon image 200c on the display screen of the operation device 40 or the like, it is possible to notify a monitor that a status change has occurred in another place even when display of the place in which the status change has occurred and which is indicated by the area image 200x is locked. The monitor can easily display another place in which the status change has occurred by performing a tapping operation of tapping the screen on which the icon image 200c is displayed in the operation device 40 with a finger or the like even when the display is locked.

In the example illustrated in FIG. 12, the image which is displayed on the display device 50 when the icon image 200c is subjected to a tapping operation in the operation device 40 may be the area image 200xy or the area image 200y. When the icon image 200c is subjected to a tapping operation or the like and the area image 200y is displayed on the display device 50, an icon image for returning the display to the area image 200x may be displayed on the operation device 40.

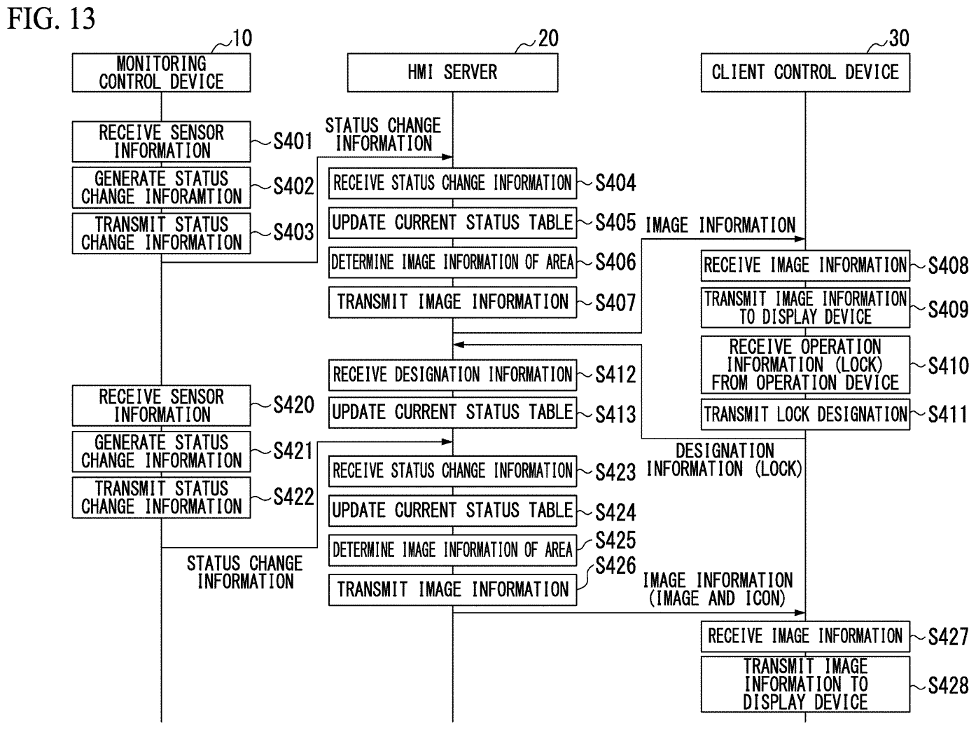

The operation illustrated in FIG. 11 will be described below with reference to FIG. 13. FIG. 13 is a sequence diagram illustrating an operation of displaying an area in which a status change has occurred in the monitoring system 1 according to the embodiment. As described above, the HMI server 20 may not change the information indicating whether display is locked or not, but it is assumed herein that the HMI server 20 updates the current status table 23 and changes the information indicating whether display is locked or not when a request signal for requesting locking of display is received from the client control device 30.

The processes of Steps S401 to S409 in the sequence chart illustrated in FIG. 13 are the same as the processes of Steps S201 to S209 in the sequence chart illustrated in FIG. 8 and thus description thereof will not be repeated.

The client control device 30 receives lock designation from the operation device 40 (Step S410). The client control device 30 transmits the received lock designation to the HMI server 20 (Step S411).

The HMI server 20 receives the lock designation from the client control device 30 (Step S412). The HMI server 20 stores information indicating that the information for designating locking of display is included in the field of display lock corresponding to the status change information indicated by the lock designation in the current status table 23 and updates the current status table 23 on the basis of the received lock designation (Step S413).

The processes of Steps S420 to S422 in the sequence chart illustrated in FIG. 13 are the same as the processes of Steps S201 to S203 in the sequence chart illustrated in FIG. 8 and thus description thereof will not be repeated.

The HMI server 20 receives status change information from the monitoring control device 10 (Step S423). The HMI server 20 stores the type of the status change, the area in which the status change has occurred, and the like in the current status table 23 on the basis of the received status change information and updates the current status table 23 (Step S424). The HMI server 20 determines image information on the basis of the received status change information (Step S425).

The HMI server 20 refers to the updated current status table 23 in order to determine image information. When a plurality of pieces of status change information are stored in the current status table 23, the HIM server 20 refers to response information for each of the plurality of pieces of status change information stored in the current status table. The HMI server 20 selects image information of a system diagram corresponding to the area in which the status change has occurred and which is indicated by the status change information indicated by designation of display lock when the status change information indicated by the designation for requesting display lock as response information is included in the plurality of pieces of status change information. Image information in which an icon image which is displayed on the operation device 40 is added to an image indicated by the selected image information is determined.

The HMI server 20 transmits the determined image information to the client control device 30 (Step S426). The client control device 30 receives the image information from the HMI server 20 (Step S427). The client control device 30 transmits the received image information to the operation device 40 and the display device 50 (Step S428). At this time, an image in which the icon image 200c (FIG. 12(d)) is added to the lower-right part of the screen displaying the area image 200x is displayed on the operation device 40. The area image 200x (FIG. 12(c)) is also displayed on the display device 50.

In the monitoring system 1, the display lock may be unlocked when designation for requesting display lock is received by the HMI server 20 and response information indicating that display of the area in which the status change has occurred is received by the HMI server 20 in Step S211. Alternatively, in the monitoring system 1, the display lock may be unlocked when designation information indicating the display lock of the area in which a status change has occurred is unlocked is received by the HMI server 20.

In the monitoring system 1, the display lock may be unlocked when designation information indicating that all the areas in which a status change has occurred are displayed by clicking the icon image 200c is received by the HMI server 20.

When information indicating that the display lock is unlocked is included in the designation information received from the client control device 30, the HMI server 20 stores information indicating that unlocking of the display lock is included in the designation information of the status number indicated by the received designation information in the current status table 23 and updates the current status table 23.

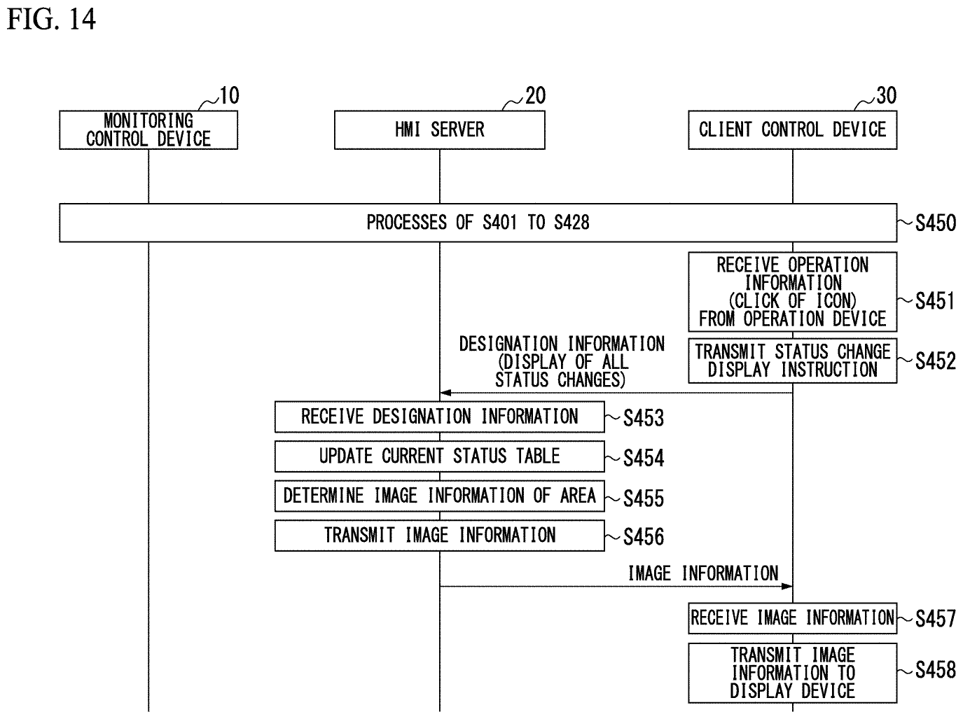

A process when the icon image 200c (FIG. 12(d)) is displayed in the lower-right part or the like of the screen displaying the area image 200x on the operation device 40, the operation device 40 is operated, and the icon image 200c is clicked in Step S428 of FIG. 13 will be described below with reference to FIG. 14. FIG. 14 is a sequence diagram illustrating an operation when the icon image 200c indicating a shortcut is clicked in an image based on the display lock in the monitoring system 1 according to the embodiment.

First, it is assumed that the processes of Steps S401 to S428 in FIG. 13 have been performed (Step S450).

The client control device 30 receives operation information indicating that the icon image 200c has been clicked from the operation device 40 (Step S451) The client control device 30 transmits designation information indicating a request for displaying some or all of a plurality of areas in which a status change has occurred to the HMI server 20 on the basis of the received operation information indicating that the icon image 200c has been clicked (Step S452).

The HMI server 20 receives the designation information indicating a request for displaying some or all of the areas in which the status change has occurred from the client control device 30 (Step S453). The HMI server 20 stores information indicating that the display lock is unlocked in the field of display lock corresponding to the status change information indicated by the lock designation in the current status table 23 on the basis of the received designation information and updates the current status table 23 (Step S454).

HMI server 20 determines image information on the basis of the status change information received from the monitoring control device 10 (Step S455). The determined image information is image information for displaying some of a plurality of areas in which a status change has occurred. The HMI server 20 transmits the determined image information to the client control device 30 (Step S456).

The client control device 30 receives the image information from the HMI server 20 (Step S457). The client control device 30 transmits the received image information to the display device 50 and displays an image on the display device 50 (Step S458).

According to the above-mentioned first embodiment, the monitoring system includes the monitoring control device 10 that monitors infrastructure facilities, the HMI server 20, and the client control device 30 that is connected to the display device 50 and the operation device 40, the monitoring control device 10 transmits infrastructure facility statuses acquired on the basis of information input from the sensor 12 to the HMI server 20, the HMI server 20 generates original image information on the basis of the infrastructure facility statuses received from the monitoring control device 10, and the client control device 30 receives information for designating a partial area of an entire image capable of being generated from the original image information from the operation device 40, transmits the received information to the HMI server 20, and displays an image based on the information received from the HMI server 20 on the display device 50. By causing the HMI server 20 to output the information for displaying a partial area of the entire image which is determined on the basis of the area designation information received from the client control device 30, it is possible to display an arbitrary area of a system diagram to be monitored and to easily cope with change of a monitoring range.

### Second Embodiment

A second embodiment will be described below.

In the first embodiment, the monitoring system 1 includes one monitoring control device 10, one HMI server 20, and one client control device 30 as illustrated in FIG. 1, but a monitoring system 1 according to the second embodiment includes one monitoring control device 10, one HMI server 20, and a plurality of client control devices 30.

The monitoring system 1 according to the second embodiment includes a plurality of client control devices 30 and can display an entire image 200, for example, by displaying images into which the entire image 200 illustrated in FIG. 3(a) is divided on the plurality of client control devices 30 to correspond to each other.

The monitoring system 1 according to the second embodiment includes a single mode and a sharing mode.

In the single mode, operation devices 40 connected to the plurality of client control devices 30 operate images which are displayed on the corresponding display devices 50.

In the sharing mode, one operation device 40 (hereinafter referred to as a master operation device 40) of the operation devices 40 connected to the plurality of client control devices 30 operates an image which is displayed on all the display devices 50 connected to the plurality of client control devices 30.

When the monitoring system 1 according to the second embodiment is in the sharing mode, the same screen is displayed on all the display devices 50 connected to the plurality of client control devices 30 by operation of the master operation device 40. When the same screen is displayed on all the display devices 50, information in an area in which a status change has occurred or the like can be shared by a plurality of monitors.

In the sharing mode, for example, the client control devices 30 transmit area designation information from the master operation device 40 to the HMI server 20. The HMI server 20 transmits image information which is determined on the basis of the received area designation information to all the client control devices included in the monitoring system 1.

The plurality of client control devices 30 may be grouped into a plurality of groups and a sub sharing mode in which information is shared may be provided for each group. In this case, the client control devices 30 receiving area designation information from a master operation device 40 for each group add an identification number for the group to the received area designation information and transmits the resultant area designation information to the HMI server 20. The HMI server 20 transmits image information which is determined on the basis of the received area designation information to a plurality of client control devices 30 corresponding to the received group identification number.

According to the above-mentioned second embodiment, the monitoring system includes the monitoring control device 10 that monitors infrastructure facilities, the HMI server 20, and a plurality of client control devices 30, and can achieve the same advantages as in the first embodiment. In addition, it is possible to display the same area image indicating an arbitrary area of a system diagram to be monitored on the display devices 50 connected to the plurality of client control devices 30 and to allow a plurality of monitors or the like that monitor the plurality of client control devices 30 to share information.

According to one of the above-mentioned embodiments, a monitoring system includes a monitoring control device 10 that monitors infrastructure facilities and transmits statuses of the infrastructure facilities acquired on the basis of information input from a sensor 12 to an HMI server 20, the HMI server 20 that generates original image information on the basis of the infrastructure facility statuses received from the monitoring control device 10, and a client control device 30 that is connected to a display device 50 and an operation device 40, receives information for designating a partial area of an entire image capable of being generated from the original image information from the operation device 40, transmits the received information to the HMI server 20, and displays an image based on information received from the HMI server 20 on the display device 50, and the HMI server 20 outputs information for displaying a partial area of the entire image, which is determined on the basis of area designation information received from the client control device 30, to the client control device 30. As a result, it is possible to easily cope with change of a monitoring range.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Monitoring system
10 Monitoring control device
11 Status change detecting unit
12 Sensor
20 HMI server
21 Area image transmitting unit
22 Storage unit
23 Current status table
30 Client control device
31 Request transmitting unit
32 Settings receiving unit
40 Operation device
50 Display device

1-14. (canceled)

15. A monitoring system comprising:
a monitoring control device that monitors infrastructure facilities and transmits statuses of the infrastructure facilities acquired on the basis of information input from a sensor to an image information providing device;
the image information providing device that generates original image information indicates an image of a whole area under control on the basis of the infrastructure facility statuses received from the monitoring control device; and
a client control device that is connected to a display device and an operation device including a touch panel, receives area designation information for designating a partial area of an entire image capable of being generated from the original image information from the operation device, the area designation information being designated by an operation for an image that is displayed on the touch panel, transmits the received information to the image information providing device, and displays an image based on information received from the image information providing device on the display device,
wherein the image information providing device transmits image information for displaying a partial area of the entire image, which is determined on the basis of the area designation information received from the client control device, to the client control device.

16. The monitoring system according to claim 15, wherein the client control device transmits the area designation information that is received from the operation device to the image information providing device, and
wherein the image information providing device transmits image information for displaying image on the basis of the original image information to the client control device when area determined on the basis of the area designation information is within a predetermined range, and transmits image information for displaying an image generated from a macro-perspective to the client control device when area determined on the basis of the area designation information departs from the predetermined range, the image generated from the macro-perspective being an image in which smaller elements are displayed in a unit area than the image on the basis of the original image information.

17. The monitoring system according to claim 15, wherein the client control device receives operation information of a scroll operation from the operation device, transmits the area designation information on the basis of the received operation information to the image information providing device, and
wherein the image information providing device transmits to the client control device image information for displaying an entire area or a partial area of the original image on the basis of the received operation information from the client control device.

18. The monitoring system according to claim 15, wherein when it has been determined that there are a plurality of areas in which the status change has occurred on the basis of the infrastructure facility statuses received from the monitoring control device and when the image information providing device receives designation information, the designation information indicating that display of one area of the plurality of areas is fixed, the image information providing device transmits image information for displaying the one area and information for displaying a shortcut icon to the client control device, the shortcut icon being for displaying another area of the plurality of areas.

19. The monitoring system according to claim 18, wherein when operation information indicating that a tapping operation has been performed on the shortcut icon is received from the operation device, the client control device transmits designation information for designating transmission of information for displaying areas including some or all of a plurality of areas in which a status change has occurred to the image information providing device.

20. A monitoring system comprising:
a monitoring control device that monitors infrastructure facilities and transmits statuses of the infrastructure facilities acquired on the basis of information input from a sensor to an image information providing device;
the image information providing device that generates original image information indicates an image of a whole area under control on the basis of the infrastructure facility statuses received from the monitoring control device; and
a client control device that is connected to a display device and an operation device, receives area designation information for designating a partial area of an entire image capable of being generated from the original image information from the operation device, transmits the received information to the image information providing device, and displays an image based on information received from the image information providing device on the display device,
wherein the image information providing device transmits image information for displaying image on the basis of the original image information to the client control device when area determined on the basis of the area designation information is within a predetermined range, and transmits image information for displaying an image generated from a macro-perspective to the client control device when area determined on the basis of the area designation information departs from the predetermined range, the image generated from the macro-perspective being an image in which smaller elements are displayed in a unit area than the image on the basis of the original image information.

21. A monitoring system comprising:
a monitoring control device that monitors infrastructure facilities and transmits statuses of the infrastructure facilities acquired on the basis of information input from a sensor to an image information providing device;
the image information providing device that generates original image information indicates an image of a whole area under control on the basis of the infrastructure facility statuses received from the monitoring control device; and
a client control device that is connected to a display device and an operation device, receives area designation information for designating a partial area of an entire image capable of being generated from the original image information from the operation device, transmits the received information to the image information providing device, and displays an image based on information received from the image information providing device on the display device,
wherein the client control device receives operation information of a scroll operation from the operation device, transmits the area designation information on the basis of the received operation information to the image information providing device,
wherein the image information providing device transmits to the client control device image information for displaying an entire area or a partial area of the original image on the basis of the received operation information from the client control device.

22. a monitoring control device that monitors infrastructure facilities and transmits statuses of the infrastructure facilities acquired on the basis of information input from a sensor to an image information providing device;
the image information providing device that generates original image information indicates an image of a whole area under control on the basis of the infrastructure facility statuses received from the monitoring control device; and
a client control device that is connected to a display device and an operation device, receives area designation information for designating a partial area of an entire image capable of being generated from the original image information from the operation device, transmits the received information to the image information providing device, and displays an image based on information received from the image information providing device on the display device,
wherein when it has been determined that there are a plurality of areas in which the status change has occurred on the basis of the infrastructure facility statuses received from the monitoring control device and when the image information providing device receives designation information, the designation information indicating that display of one area of the plurality of areas is fixed, the image information providing device transmits image information for displaying the one area and information for displaying a shortcut icon to the client control device, the shortcut icon being for displaying another area of the plurality of areas.

23. An image information providing device that generates original image information indicates an image of a whole area under control on the basis of infrastructure facility statuses, and transmits image information for displaying a partial area of an entire image to a monitoring control device, the entire image determined on the basis of area designation information for designating a partial area of an entire image capable of being generated from the original image information,
wherein when it has been determined that there are a plurality of areas in which the status change has occurred on the basis of the infrastructure facility statuses received from the monitoring control device and when the image information providing device receives designation information, the designation information indicating that display of one area of the plurality of areas is fixed, the image information providing device transmits image information for displaying the one area and information for displaying a shortcut icon to the client control device, the shortcut icon being for displaying another area of the plurality of areas.

24. A client control device that is connected to a display device and an operation device including a touch panel, receives area designation information for designating a partial area of an entire image capable of being generated from the original image information from the operation device, the area designation information being designated by an operation for an image that is displayed on the touch panel, transmits the received information to the image information providing device, and receives information for displaying a partial area of the entire image, which is determined on the basis of the area designation information.

25. An image information providing program causing an image information providing device to generate original image information indicates an image of a whole area under control on the basis of infrastructure facility statuses, and to transmit image information to a client control device, the image information being for displaying a partial area of an entire image to a client control device, the entire image being determined on the basis of area designation information for designating a partial area of an entire image capable of being generated from the original image information,
wherein when it has been determined that there are a plurality of areas in which the status change has occurred on the basis of the infrastructure facility statuses received from the monitoring control device and when the image information providing device receives designation information, the designation information indicating that display of one area of the plurality of areas is fixed, the image information providing program causing the image information providing device to transmit image information for displaying the one area and information for displaying a shortcut icon to the client control device, the shortcut icon being for displaying another area of the plurality of areas.

26. A client control program causing a client control device connected to a display device and an operation device including a touch panel, to receive area designation information for designating a partial area of an entire image capable of being generated from original image information indicates an image of a whole area under control generated on the basis of infrastructure facility statuses from the operation device, the area designation information being designated by an operation for an image that is displayed on the touch panel, to transmit the received area designation information to an image information providing device, and to receive information for displaying a partial area of the entire image, which is determined on the basis of the area designation information, from the image information providing device.
